(19) United States
(12) Patent Application Publication
(10) Pub. No.: US 2020/0307007 A1
(43) Pub. Date: Oct. 1, 2020

(54) CUTTING CUTTER

(71) Applicant: HASEGAWA CUTLERY CO., LTD., Gifu-ken (JP)

(72) Inventor: Bungo HASEGAWA, Gifu (JP)

(21) Appl. No.: 16/657,554

(22) Filed: Oct. 18, 2019

(30) Foreign Application Priority Data
Mar. 26, 2019 (JP) 2019-058731

(51) Int. Cl. B26D 1/04; B26B 27/00; B26B 29/06

(52) U.S. Cl. CPC B26D 1/04; B65B 69/0033; B26B 29/06; B26B 27/00

(57) ABSTRACT

A cutting cutter (10) includes: a blade piece (50) that is held on a blade piece holding part (30) so as to extend at least in a second direction (DB); and a guard part (70) that is movable, relative to the blade piece holding part (30), between a guard position in which a distal end of a blade edge (51) of the blade piece (50) is covered from one side in the second direction (DB), and an exposure position in which the distal end of the blade piece (50) is exposed to the one side in the second direction (DB); wherein when a first contact part (23) of a body part (20) is brought into contact with one surface (3) of a package (1), the guard part (70) is pushed by the one surface (3) from the guard position to the exposure position.

### CROSS-REFERENCE TO RELATED APPLICATIONS

This application is based upon and claims the benefit of priority from Japanese Patent Application No. 2019-058731, filed Mar. 26, 2019; the entire contents of which are incorporated herein by reference.

### BACKGROUND OF THE INVENTION

### Field of the Invention

The present invention relates to a cutting cutter for cutting a package.

### Background Art

It is known that a plurality of articles are packed in a package such as a cardboard box, distributed and stored. In order to display the articles in a shop or to deliver a required quantity of articles to a consumer, the package is opened during the distribution process of the articles. Opening of the package is generally done by using a cutter. JP2001-322615A discloses a cutter for opening packages.

One of the needs for a package opening cutter is that the cutter is easy to handle. For example, it is desired that a cutter can be safely carried and/or that the cutter is easy to be operated when cutting.

The present invention has been made in view of the above circumstances. The object of the present invention is to provide a cutting cutter that is easy to handle.

### BRIEF SUMMARY OF THE INVENTION

A cutting cutter according to the present invention is a cutting cutter that cuts a package while moving on a corner area of the package, comprising:

a body part having a first contact part that slides on one surface of the package when cutting, the one surface spreading both in a first direction that is a moving direction of the cutting cutter when cutting (and a longitudinal direction of the corner area) and in a second direction orthogonal to the first direction and forming the corner area;

a blade piece holding part having a second contact part that slides on the other surface of the package when cutting, the other surface spreading both in a third direction that is not parallel to the second direction and in the first direction and forming the corner area together with the one surface, the blade piece holding part being fixed to the body part;

a blade piece that is held on the blade piece holding part so as to extend at least in the second direction; and

a guard part that is movable, relative to the blade piece holding part, between a guard position in which a distal end of a blade edge of the blade piece is covered from one side in the second direction, the one side being opposite to the blade piece holding part, and an exposure position in which the distal end of the blade piece is exposed to the one side in the second direction;

wherein, when the first contact part of the body part is brought into contact with the one surface of the package, the guard part is pushed by the one surface from the guard position to the exposure position.

In the cutting cutter according to the present invention, the guard part may be movable along a direction perpendicular both to the first direction and to the second direction.

In the cutting cutter according to the present invention, the guard part may be positioned inside the body part, when it is located at the exposure position.

Alternatively, a cutting cutter according to the present invention is a cutting cutter that cuts a package while moving on a corner area of the package, comprising:

a body part having: a first contact part that slides on one surface of the package when cutting, the one surface spreading both in a first direction that is a moving direction of the cutting cutter when cutting and in a second direction orthogonal to the first direction and forming the corner area; and a grip part gripped by a user when cutting;

a blade piece holding part having a second contact part that slides on the other surface of the package when cutting, the other surface spreading both in a third direction that is not parallel to the second direction and in the first direction and forming the corner area together with the one surface, the blade piece holding part being fixed to the body part; and

a blade piece that is held on the blade piece holding part so as to extend at least in the second direction;

wherein in a projection in a direction perpendicular both to the first direction and to the second direction, a distal end of the blade piece is overlapped with the grip part.

Alternatively, a cutting cutter according to the present invention is a cutting cutter that cuts a package while moving on a corner area of the package, comprising:

a body part having: a first contact part that slides on one surface of the package when cutting, the one surface spreading both in a first direction that is a moving direction of the cutting cutter when cutting and in a second direction orthogonal to the first direction and forming the corner area; and a grip part gripped by a user when cutting;

a blade piece holding part having a second contact part that slides on the other surface of the package when cutting, the other surface spreading both in a third direction that is not parallel to the second direction and in the first direction and forming the corner area together with the one surface, the blade piece holding part being fixed to the body part; and

a blade piece that is held on the blade piece holding part so as to extend at least in the second direction;

wherein a blade edge of the blade piece is at an angle greater than 0° and smaller than 45° with respect to a plane that is parallel both to the first direction and to the second direction.

Alternatively, a cutting cutter according to the present invention is a cutting cutter that cuts a package while moving on a corner area of the package, comprising:

a body part having: a first contact part that slides on one surface of the package when cutting, the one surface spreading both in a first direction that is a moving direction of the cutting cutter when cutting and in a second direction orthogonal to the first direction and forming the corner area; and a grip part gripped by a user when cutting;

a blade piece holding part having a second contact part that slides on the other surface of the package when cutting, the other surface spreading both in a third direction that is not parallel to the second direction and in the first direction and forming the corner area together with the one surface, the blade piece holding part being fixed to the body part; and

a blade piece that is held on the blade piece holding part so as to extend at least in the second direction;

wherein the blade piece holding part holds the blade piece such that the blade piece can be changed in position between a first position in which a blade edge of the blade piece is oriented to one side in the first direction, and a second position in which the blade edge is oriented to the other side in the first direction.

Alternatively, a cutting cutter according to the present invention is a cutting cutter that cuts a package while moving on a corner area of the package, comprising:

a body part having: a first contact part that slides on one surface of the package when cutting, the one surface spreading both in a first direction that is a moving direction of the cutting cutter when cutting and in a second direction orthogonal to the first direction and forming the corner area; and a grip part gripped by a user when cutting;

a blade piece holding part having a second contact part that slides on the other surface of the package when cutting, the other surface spreading both in a third direction that is not parallel to the second direction and in the first direction and forming the corner area together with the one surface, the blade piece holding part being fixed to the body part; and

a blade piece that is held on the blade piece holding part so as to extend at least in the second direction;

wherein the second contact part linearly extends along the first direction.

According to the present invention, a cutter easy to handle can be provided.

### BRIEF DESCRIPTION OF THE DRAWINGS

FIG. 1 is a view showing an embodiment of a cutting cutter according to the present invention, FIG. 1 being a perspective view showing a package and the cutting cutter which cuts the package.

FIG. 2 is an enlarged perspective view showing the cutting cutter shown in FIG. 1.

FIG. 3 is a view in which the cutting cutter shown in FIG. 2 during cutting is seen in a first direction.

FIG. 4 is a view corresponding to FIG. 3, in which the cutting cutter is not in use.

FIG. 5 is a perspective view of the cutting cutter shown in FIG. 4, which is seen from the side of a first contact part and a second contact part.

FIG. 6 is a view in which the cutting cutter shown in FIG. 4 is seen in a direction perpendicular both to a first direction and to a second direction.

FIG. 7 is an exploded perspective view showing a blade piece holding part.

FIG. 8 is a perspective view showing a blade piece mounting part and a blade piece

FIG. 9 is an exploded perspective view showing a guard unit.

### DETAILED DESCRIPTION OF THE INVENTION

An embodiment of the present invention is described herebelow with reference to the drawings.

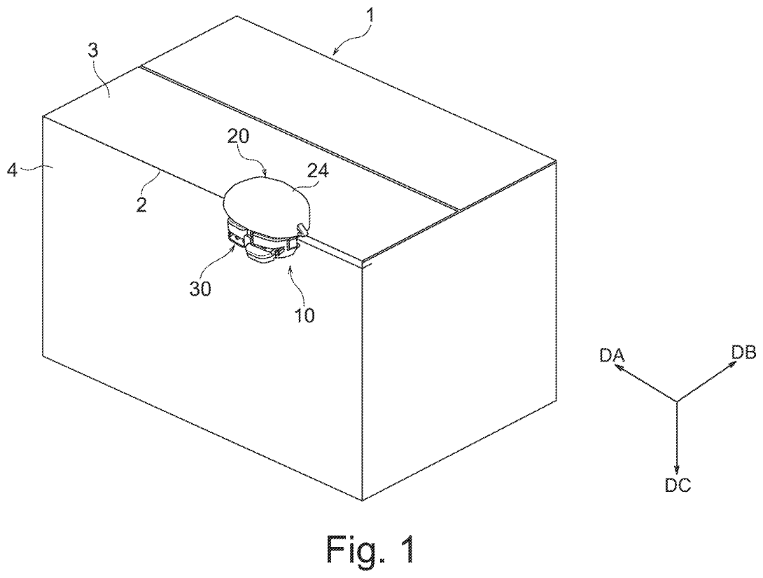

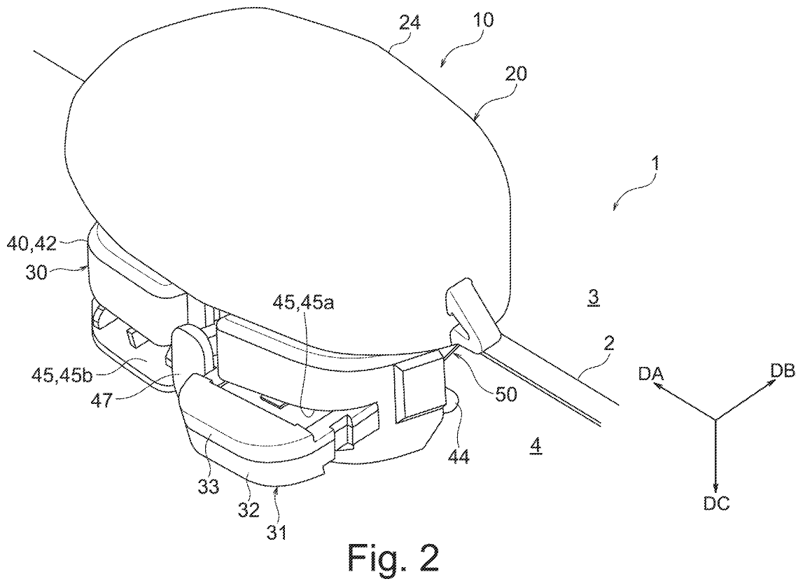

FIG. 1 is a view for describing an embodiment of a cutting cutter 10 according to the present invention. FIG. 1 is a perspective view of the cutting cutter 10 that cuts a package 1. In addition, FIG. 2 is an enlarged view of the cutting cutter 10 shown in FIG. 1. The cutting cutter 10 cuts the package 1 along a corner area 2 of the package 2 while moving on the corner area 2. Such a cutting cutter 10 is used for opening the package 1.

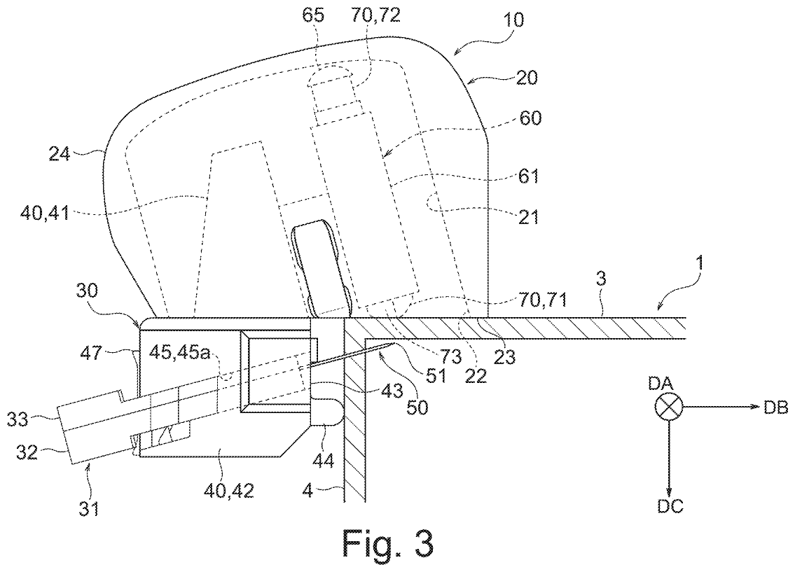

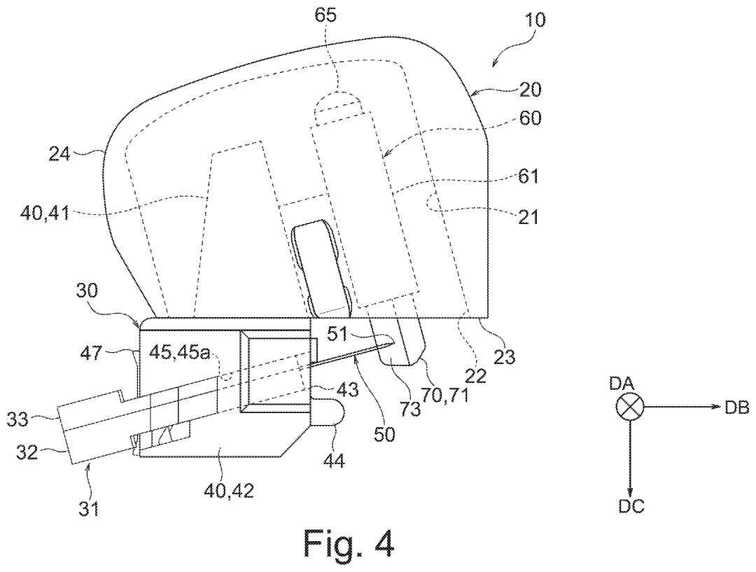

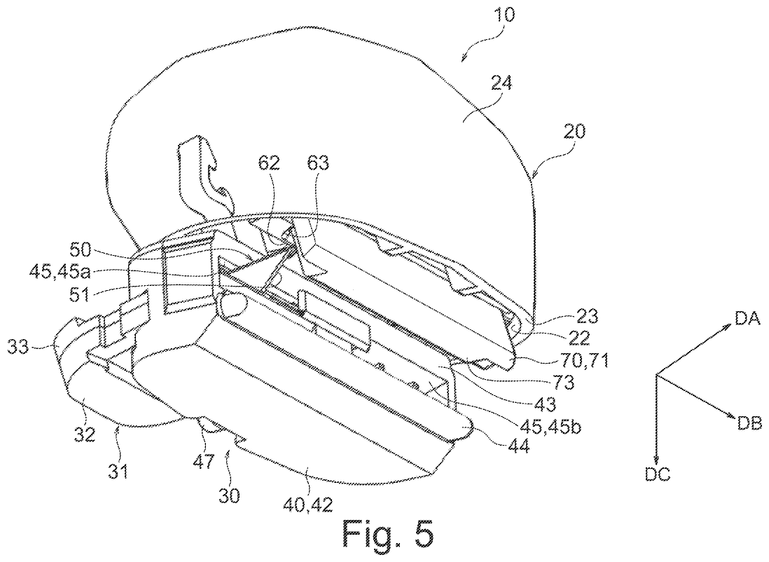

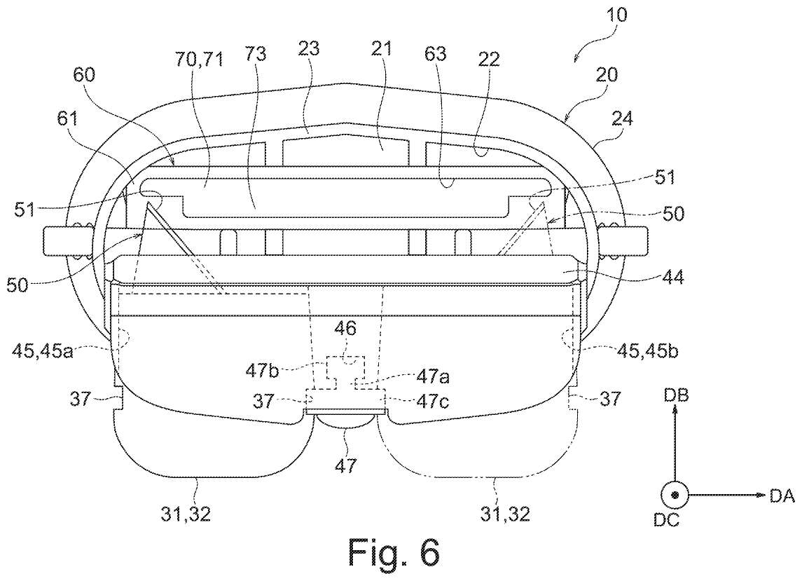

FIG. 3 is a view in which the cutting cutter 10 shown in FIG. 1 is seen in a moving direction when cutting (a longitudinal direction of the corner area 2) DA. In FIG. 3, a section of the package 1 being cut, which is perpendicular to the moving direction DA, is shown together with the cutting cutter 10. FIG. 4 is a view showing the cutting cutter 10 not in use (thus, the cutting cutter 10 which is away from the package 1). FIG. 5 is a perspective view of the cutting cutter 10 shown in FIG. 4, which is seen from the side of a first contact part 23 and a second contact part 44 described below. FIG. 6 is a plan view of the cutting cutter 10 shown in FIG. 4, which is seen from the side of the first contact part 23.

In the below description, one and the other surfaces 3, 4 forming the corner area 2 of the package 1 are referred to as “first surface 3” and “second surface 4”. The “first direction DA” is a moving direction of the cutting cutter 10 during the cutting of the package 1. Also, a “second direction DB” is a direction that is orthogonal to the first direction DA, along which the first surface 3 spreads in addition to the first direction DA. A “third direction DC” is a direction that is not parallel to the first direction DA or to the second direction DB, along which the second surface 4 spreads in addition to the first direction DA.

In order to clarify the directional relationship of the drawings, in some drawings, the first direction DA, the second direction DB and the third direction DC are shown as arrows that are common in the drawings. A tip (head) side of each arrow indicates “one side” in each direction DA, DB, DC. A tail side of each arrow indicates “the other side” in each direction DA, DB, DC. In addition, as shown in FIGS. 3 and 4, an arrow extending rearward (inward) of a paper surface/drawing plane of a drawing along a direction perpendicular to the paper surface/drawing plane is represented by a circled X. An arrow extending forward (outward) from a paper surface/drawing plane of a drawing along a direction perpendicular to the paper surface/drawing plane is represented by a circled dot.

As shown in FIGS. 2 to 6, the cutting cutter 10 has a body part 20, a blade piece holding part 30 fixed to the body 20, and a blade piece 50 held on the blade piece holding part 30. Further, the cutting cutter 10 has a guard unit 60 including a guard part 70 that covers at least a part of a blade edge 51 of the blade piece 50.

Respective parts of the cutting cutter 10 are described herebelow in more detail.

<Body Part>

The body part 20 is firstly described. The body part 20 holds the blade piece holding part 30 and the guard unit 60. In the illustrated example, the body part 20 has an inside space 21 formed therein. The inside space 21 at least partially accommodates the blade piece holding part 30 and the guard unit 60. An opening 22 in communication with the inside space 21 is formed in one end of the body part 20 in the third direction DC. The blade piece holding part 30 and the guard unit 60 can be inserted into the inside space 21 through the opening 22.

In addition, the body part 20 has a first contact part 23 which slides on the first surface 3 of the package 1 during cutting. In the illustrated example, a part of a rim defining the opening 22 of the body part 20 serves as the first contact part 23.

The body part 20 is provided with a grip part 24 gripped by a user when cutting. In the illustrated example, a part of an outer surface of the body part 20 other than a part on the one side in the third direction DC (the side on which the first contact part 23 is provided) serves as the grip part 24.

<Blade Piece and Blade Piece Holding Part>

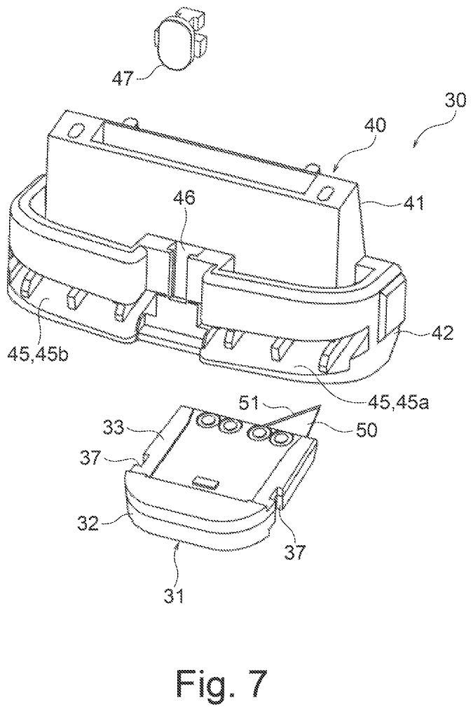

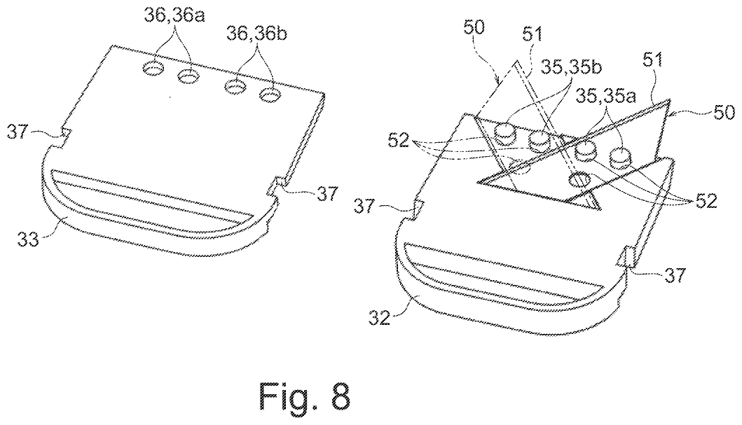

Next, the blade piece 50 and the blade piece holding part 30 are described with reference to FIGS. 2 to 8. FIG. 7 is an exploded perspective view of the blade piece holding part 30. In FIG. 7, the blade piece 50 is mounted on a below-described blade piece mounting part 31 of the blade piece holding part 30. FIG. 8 shows an exploded view of the blade piece mounting part 31 together with the blade piece 50.

The blade piece 50 is firstly described. As shown in FIG. 8, the blade piece 50 is a laminar cutter blade. In the illustrated example, the blade piece 50 has a trapezoidal shape in a plan view. The blade edge 51 is provided along one of rims of parallel opposite sides of the trapezoid. The blade piece 50 is provided with holes 52 for fixing the blade piece 50 to the blade piece holding part 30.

Next, the blade piece holding part 30 is described. As shown in FIG. 7, the blade piece holding part 30 has the blade piece mounting part 31 on which the blade piece 50 is mounted, a connection part 40 that holds the blade piece mounting part 31 and is connected to the body part 20, and a locking member 47 for fixing the blade piece mounting part 31 to the connection part 40.

As shown in FIGS. 7 and 8, the blade piece mounting part 31 includes a pair of plate-like members 32, 33. A blade piece is sandwiched between the pair of plate-like members 32, 33. One plate-like member 32 has projections 35 correspondingly to the holes 52 of the blade piece 50. The other plate-like member 33 has recesses 36 correspondingly to the projections 35. By fitting the projections 35 of the one plate-like member 32 in the holes 52 of the blade piece 50 and then fitting them in the recesses 36 of the other plate-like member 33, the blade-piece 50 is fixed to the blade piece mounting part 31. As shown in FIGS. 3 and 4, the blade piece mounting part 31 is held by the connection part 40 by inserting the blade piece mounting part 31 into a below-described insertion hole 45 of the connection part 40. In order to facilitate the insertion of the blade piece mounting part 31 into the insertion hole 45, the blade piece mounting part 31 is tapered such that its size along the first direction DA gradually decreases toward the one side in the second direction DB. The one side and the other side of the blade piece mounting part 31 in the first direction DA are respectively provided with a fixing recess 37 in which the locking member 47 is fitted.

In the example shown in FIG. 8, the one plate-like member 32 has first projections 35a that are fitted in the holes 52 in the blade piece 50 whose blade edge 51 faces the one side in the first direction DA, and second projections 35b that are fitted in the holes 52 in the blade piece 50 whose blade edge 51 is oriented to the other side in the first direction DA. In addition, the other plate-like member 33 has first recesses 36a in which the first projections 35a are fitted, and second recesses 36b in which the second projections 35b are fitted. Thus, the blade piece holding part 30 can hold the blade piece 50 such that the blade piece 50 can be changed in position between a first position in which the blade edge 51 is oriented to the one side in the first direction DA (a position shown by solid lines in FIGS. 6 and 8) and a second position (a position shown by two-dot chain lines in FIGS. 6 and 8) in which the blade edge is oriented to the other side in the first direction DA.

As shown in FIGS. 4 and 7, the connection part 40 has a connection protrusion 41 to be accommodated in the inside space 21 of the body part 20, and a connection part body 42 connected to the connection protrusion 41 and holding the blade piece mounting part 31. The connection part 40 is fixed to the body part 20 by fastening the connection protrusion 41 to the body part 20 by using a fastening member, not shown.

The connection part body 42 is positioned on the one side of the connection protrusion 41 in the third direction DC. The connection part body 42 has a package facing part 43 that is oriented to the one side in the second direction DB. When cutting, the package facing part 43 faces the second surface 4 of the package 1. The package facing part 43 has a second contact part 44 that slides on the second surface 4 of the package 1 during cutting. In the illustrated example, the package facing part 43 has a projection projecting to the one side in the second direction DB. This projection serves as the second contact part 44. Since only a part of the package facing part 43 is in contact with the package 1 during the cutting of the package 1, a frictional force acting between the connection part body 42 (blade piece holding part 30) and the package 1 is reduced. As a result, an operability of the cutting cutter 10 when cutting can be improved.

Further, in the illustrated example, the second contact part 44 linearly extends along the first direction DA. Due to such a second contact part 44, when the cutting cutter 10 is moved in the first direction DA, a frictional force acting between the cutting cutter 10 and the package 1 during cutting can be minimized. Thus, during the cutting of the package 1, the cutting cutter 10 can be restrained from moving in a direction other than the first direction DA. This also improves the operability of the cutting cutter 10 when cutting.

The connection part body 42 is provided with the insertion hole 45 for inserting the blade piece mounting part 31. The insertion hole 45 passes through the connection part body 42, from one side to the other side thereof, in the second direction DB. As shown in FIG. 4, in a state where the blade piece mounting part 31 in inserted in the insertion hole 45, the blade piece 50 mounted on the blade piece mounting part 31 extends from the package facing part 43 at least in the second direction DB.

In addition, as shown in FIG. 6, in the state where the blade piece mounting part 31 is inserted in the insertion hole 45, the distal end of the blade piece 50 mounted on the blade piece mounting part 31 overlaps with the grip part 24 in a projection in a direction perpendicular both to the first direction DA and to the second direction DB. Since the distal end of the blade piece 50 overlaps with the grip part 24 in the aforementioned projection, a force applied to the grip part 24 by a user can be efficiently transmitted to the package 1 through the distal edge of the blade piece 50. As a result, it is easy to cut the package 1.

In addition, as shown in FIG. 3, the insertion hole 45 is provided such that the blade edge 51 of the blade piece 50 mounted on the blade piece mounting part 31 is at an angle greater than 0° and smaller than 45° with respect to a plane (the first surface 3 of the package 1) that is parallel both to the first direction DA and to the second direction DB. When the blade edge 51 of the blade piece 50 is at an angle greater than 0° with respect to a plane parallel both to the first direction DA and the second direction DB, the blade edge 51 of the blade piece 50 extends in the corner area 2 of the package 1. As a result, an article accommodated in the package 1 can be prevented from being damaged by the blade piece 50. In addition, when the blade edge 51 of the blade piece 50 is at an angle smaller than 45° with respect to a plane parallel both to the first direction DA and to the second direction DB, out of a force received by the blade piece 50 from the package 1 during the cutting of the package 1, a force directed from the package 1 toward the other side in the second direction DB (the side away from the package 1) can be reduced. Thus, during the cutting of the package 1, it can be avoided that the cutting cutter 10 is deviated from the corner area 2 of the package 1. As a result, it is easy to move the cutting cutter 10 along the corner area 2 of the package 1, whereby the operability of the cutting cutter 10 improves.

As shown in FIGS. 2 and 6, the connection part body 42 has two insertion holes 45a, 45b that are arranged side by side in the first direction DA. Thus, the position of the blade piece 50 with respect to the body part 20 can be suitably changed in accordance with a dominant hand of a user, for example. For example, in the case of a right-handed user, as shown by solid lines in FIG. 6, the blade piece mounting part 31 is inserted into one insertion hole 45a, with the blade edge 51 being oriented to the one side in the first direction DA (with the blade piece 50 being located in the first position). On the other hand, in the case of a left-handed user, as shown by two-dot chain lines in FIG. 6, the blade piece mounting part 31 is inserted into the other insertion hole 45b, with the blade edge 51 being oriented to the other side in the first direction DA (with the blade piece 50 being located in the second position). Thus, either a right-handed user or a left-handed user can move, with his/her dominant hand, the cutting cutter 10 along the corner area 2 of the package 1 in the first direction DA. This also improves the operability of the cutting cutter 10.

Next, the locking member 47 is described. As shown in FIGS. 6 and 7, the connection part body 42 is provided, between the insertion holes 45a and 45b, with a guide groove 46 that extends in the third direction DC. Correspondingly thereto, the locking member 47 has a locking member body 47a that extends in the second direction DB, a first projection 47b that extends from the one side end of the locking member body 47a in the second direction DB to the one side and the other side in the first direction DA, and a second projection 47c that extends, nearer to the other side in the second direction DB than the first projection 47b, from the locking member body 47a to the one side and the other side in the first direction DA. By fitting the first projection 47b in the guide groove 46 of the connection part body 42, the locking member 47 is held movably in the third direction DC with respect to the connection part body 42. In addition, by fitting the second projection 47c in the fixing recess 37 of the blade piece mounting part 31, the locking member 47 fixes the blade piece mounting part 31 to the connection part body 42.

<Guard Unit>

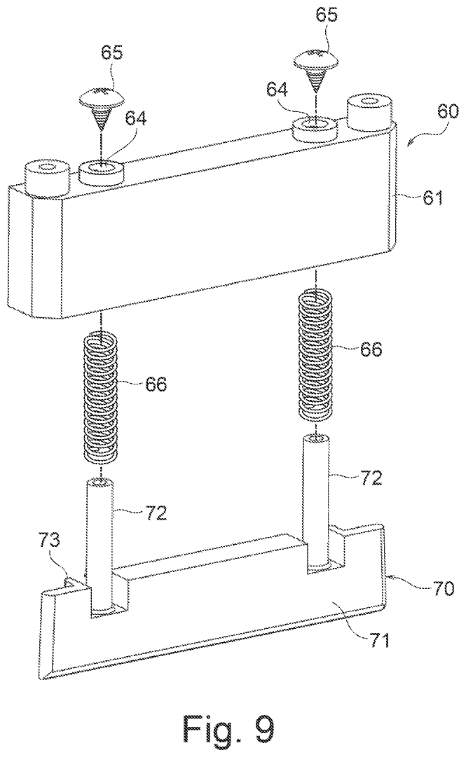

Next, the guard unit 60 is described with reference to FIGS. 3 to 6 and 9. FIG. 9 is an exploded perspective view of the guard unit 60.

As shown in FIG. 9, the guard unit 60 includes a guard part holder 61 fixed to the body part 20, and a guard part 70 held on the guard part holder 61. The guard part 70 is held movably with respect to the guard part holder 61 (thus, with respect to the body part 20 and the blade piece holding part 30). To be specific, the guard part 70 can be moved with respect to the body part 20 and the blade piece holding part 30 between a guard position (see FIG. 4) in which the blade edge 51 of the blade piece 50 is covered, and an exposure position (see FIG. 3) in which the blade edge 51 of the blade piece 50 is exposed.

At the guard position shown in FIG. 4, the guard part 70 covers the distal end of the blade edge 51 of the blade piece 50 from the one side in the second direction DB (the side opposite to the blade piece holding part 30). Thus, when the guard part 70 is located at the guard position, the risk of damaging a hand of a user and other things by the blade edge 51 can be reduced.

On the other hand, at the exposure position shown in FIG. 3, the guard part 70 exposes the distal end of the blade edge 51 of the blade piece 50 to the one side in the second direction DB. Thus, when the guard part 70 is located at the exposure position, the package 1 can be cut by pressing the distal end of the blade edge 51 onto the package 1.

In the illustrated example, the guard part 70 includes a generally plate-like guard part body 71. The guard part body 71 is substantially along a plane extending both in the first direction DA and in the third direction DC. Two shaft parts 72 extend in the third direction DC from the other side of the guard part body 71 in the third direction DC.

As shown in FIG. 4, the guard part holder 61 is accommodated as a whole in the inside space 21 of the body part 20, and is fixed to the body part 20 by a fastening member, not shown. As shown in FIG. 5, the guard part holder 61 has an inside space 62 in which the guard part body 71 is accommodated. The inside space 62 is opened through a first opening 63 formed in one side of the guard part holder 61 in the third direction DC (the side of the first contact part 23 of the body part 20). The guard part body 71 can enter into and exit from the inside space 62 of the guard part holder 61 through the first opening 63. The guard part body 71 enters into and exits from the inside space 62 along a direction (in the illustrated example, the third direction DC) perpendicular both to the first direction DA and to the second direction DB.

Second openings 64 are provided on the other side of the guard part holder 61 in the third direction DC. The shaft parts 72 of the guard part 70 are inserted to the second openings 64. A stopper 65 is connected to a distal end of each shaft part 72 inserted in the second opening 64. A head part of each stopper 65 is positioned outside the guard part holder 61. An external diameter of the head part is larger than a caliber of the second opening 64. Such a stopper 65 prevents the guard part 70 from being separated from the guard part holder 61.

As can be understood from FIG. 9, an urging means 66 urging the guard part 70 toward the guard position is disposed between the guard part body 71 and the guard part holder 61. In the illustrated example, the urging means 66 is a coil spring which is disposed to surround each shaft part 72 of the guard part 70 inside the guard part holder 61. Due to the provision of the urging means 72, when no force is applied to the guard part 70 (e.g., when the first contact part 23 of the body part 20 is sufficiently away from the package 1), the guard part 70 is located at the guard position so as to cover the distal end of the blade piece 50. On the other hand, when the guard part 70 is subjected to a force directed toward the body part 20 along a direction perpendicular both to the first direction DA and to the second direction DB (e.g., when the first contact part 23 of the body part 20 is bought into contact with the package 1), the guard part 70 is moved to the exposure position against the urging force of the urging means 66 so as to expose the distal end of the blade piece 50. In other words, when the cutting cutter 10 is not in use, the guard part 70 covers the distal end of the blade piece 50. On the other hand, when cutting of the package 1, the guard part 70 automatically exposes the distal end of the blade piece 50. When not in use, the cutting cutter 10 having such a guard part 70 can be safely carried thanks to the guard function of the guard part 70, while, upon use, a special operation for cancelling the guard function is not needed. Thus, the cutting cutter 10 having such a guard part 70 is easy to handle.

Further, in the illustrated example, the guard part 70 is positioned inside the body part 20, when it is located at the exposure position. Thus, it is possible to prevent the moving guard part 70 from interfering with surrounding objects of the cutting cutter 10 (e.g., the package 1, a user's hand, etc.). Thus, the cutting cutter is furthermore easy to handle.

In addition, in the example shown in FIG. 6, the guard part body 71 has a bulged part 73 that bulges in the center in the second direction DB toward the blade piece holding part 30. Due to the provision of the bulged part 73, a gap formed between the blade piece holding part 30 and the guard part body 71 can be small enough. Thus, it is effectively possible to prevent a user's finger, etc., from being caught in the gap and being damaged by the blade piece 50. In addition, the distal end of the blade piece 50 can be covered from the one side or the other side in the first direction DA. Thus, a risk of damaging the user's finger, etc., by the distal end of the blade piece 50 can be further reduced.

<How to Use>

Next, how to use the aforementioned cutting cutter 10 is described.

Firstly, a case in which the package 1 is cut by positioning the cutting cutter 10 on the corner area 2 of the package 1 as shown in FIG. 1 and by moving the cutting cutter 10 to the one side in the first direction DA is described. In this case, the blade piece 50 is held by the blade piece holding part 30 such that the position of the blade piece 50 is the first position (the position shown by solid lines in FIG. 6) in which the blade edge 51 is oriented to the one side in the first direction DA. At this time, as shown by the solid lines in FIG. 6, the blade piece mounting part 31 is inserted into the insertion hole 45a located on the other side in the first direction DA out of the two insertion holes 45a, 45b of the connection part body 42 so as to hold the blade piece 50 on the blade piece holding part 30. Thus, the blade edge 51 of the blade piece 50 is oriented to the bulged part 73 of the guard part body 71. The distal end of the blade edge 51 of the blade piece 50 is covered with the guard part body 71 from the one side in the second direction DB and the one side in the first direction DA.

Then, the cutting cutter 10 is moved along a direction perpendicular both to the first direction DA and the second direction DB so as to bring the first contact part 23 of the body part 20 into contact with the first surface 3 of the package 1. Thus, the guard part 70 is moved along the above perpendicular direction so as to be accommodated in the body part 20. In accordance therewith, the distal end of the blade piece 50 is exposed to the one side in the second direction DB (the side facing the second surface 4 of the package) and the one side in the first direction DA. The cutting cutter 10 is moved to the one side in the first direction DA along the corner area 2 of the package 1, with sliding the first contact part 23 of the body part 20 on the first surface 3 of the package 1 and also sliding the second contact part 44 of the blade piece holding part 30 on the second surface 4 of the package 1. Thus, the second surface 4 of the package 1 is cut along the corner area 2.

In a case in which the package 1 is cut by positioning the cutting cutter 10 on the corner area 2 of the package 1 as shown in FIG. 1 and by moving the cutting cutter 10 to the other side in the first direction DA, the blade piece 50 is held by the blade piece holding part 30 such that the position of the blade piece 50 is the second position (the position shown by two-dot chain lines in FIG. 6) in which the blade edge 51 is oriented to the other side in the first direction DA. At this time, as shown by the two-dot chain lines in FIG. 6, the blade piece mounting part 31 is inserted into the insertion hole 45b located on the one side in the first direction DA out of the two insertion holes 45a, 45b of the connection part body 42 so as to hold the blade piece 50 on the blade piece holding part 30. Thus, the blade edge 51 of the blade piece 50 is oriented to the bulged part 73 of the guard part body 71. The distal end of the blade edge 51 of the blade piece 50 is covered with the guard part body 71 from the one side in the second direction DB and the other side in the first direction DA.

As described above, according to this embodiment, the cutting cutter 10 that cuts the package 1 while moving on the corner area 2 of the package 1 comprises the body part 20 having the first contact part 23 which slides on one surface 3 of the package 1 when cutting, the one surface 3 spreading both in the first direction DA that is a moving direction of the cutting cutter 10 when cutting (the longitudinal direction of the corner area 2) and in the second direction DB orthogonal to the first direction DA and forming the corner area 2. In addition, the cutting cutter 10 comprises: the blade piece holding part 30 having the second contact part 44 that slides on the other surface 4 of the package 1 when cutting, the other surface 4 spreading both in the third direction DC that is not parallel to the second direction DB and in the first direction DA and forming the corner area 2 together with the one surface 3, the blade piece holding part 30 being fixed to the body part; and the blade piece 50 that is held on the blade piece holding part 30 so as to extend at least in the second direction DB. In addition, the cutting cutter 10 comprises the guard part 70 that is movable, relative to the blade piece holding part 30, between a guard position in which the distal end of the blade edge 51 of the blade piece 50 is covered from the one side in the second direction DB, the one side being opposite to the blade piece holding part 30, and the exposure position in which the distal end of the blade piece 50 is exposed to the one side in the second direction DB. When the first contact part 23 of the body part 20 is brought into contact with the one surface 3 of the package 1, the guard part 70 is pushed by the one surface 3 from the guard position to the exposure position.

According to such a cutting cutter 10, the distal end of the blade edge 51 of the blade piece 50 is covered with the guard part 70 when not in use, whereby it is possible to prevent a user's hand, etc., from being damaged by the blade edge 51. Meanwhile, upon use, only by bringing the first contact part 23 of the body part 20 into contact with the package 1, the distal end of the blade piece 50 can be exposed to cut the package 1. Thus, the cutting cutter 1 is easy to handle.

In this embodiment, the guard part 70 can be moved along a direction perpendicular both to the first direction and to the second direction DB. Thus, the moving direction of the guard part 70 is a direction along which the cutting cutter 10 is moved when the first contact part 23 of the body part 20 is brought into contact with the package 1. As a result, the guard part 70 can be easily moved to the exposure position.

In addition, in this embodiment, the guard part 70 is positioned inside the body part 20, when it is located at the exposure position. Thus, it is possible to prevent the guard part 70 which has moved to the exposure position from interfering with surrounding objects of the cutting cutter 10 (e.g., the package 1, a user's hand, etc.). Thus, the cutting cutter is furthermore easy to handle.

In addition, in this embodiment, the cutting cutter 10 that cuts the package 1 while moving on the corner area 2 of the package 1 comprises the body part 20 which has: the first contact part 23 that slides on one surface 3 of the package 1 when cutting, the one surface 3 spreading both in the first direction DA that is a moving direction of the cutting cutter 10 when cutting and in the second direction DB orthogonal to the first direction DA and forming the corner area 2; and the grip part 24 gripped by a user when cutting. In addition, the cutting cutter 10 comprises: the blade piece holding part 30 having the second contact part 44 that slides on the other surface 4 of the package 1 when cutting, the other surface 4 spreading both in the third direction DC that is not parallel to the second direction DB and in the first direction DA and forming the corner area 2 together with the one surface 3, the blade piece holding part 30 being fixed to the body part 20; and the blade piece 50 that is held on the blade piece holding part 30 so as to extend at least in the second direction DB. In the projection in a direction perpendicular both to the first direction DA and to the second direction DB, the distal edge of the blade piece 50 overlaps with the grip part 24.

According to such a cutting cutter 10, a force given to the grip part 24 by a user can be efficiently transmitted to the package 1 through the distal edge of the blade piece 50. As a result, it is easy to cut the package 1. Namely, the operability of the cutting cutter 10 improves.

In addition, in this embodiment, the cutting cutter 10 that cuts the package 1 while moving on the corner area 2 of the package 1 comprises the body part 20 which has: the first contact part 23 that slides on one surface 3 of the package 1 when cutting, the one surface 3 spreading both in the first direction DA that is a moving direction of the cutting cutter 10 when cutting and in the second direction DB orthogonal to the first direction DA and forming the corner area 2; and the grip part 24 gripped by a user when cutting. In addition, the cutting cutter 10 comprises: the blade piece holding part 30 having the second contact part 44 that slides on the other surface 4 of the package 1 when cutting, the other surface 4 spreading both in the third direction DC that is not parallel to the second direction DB and in the first direction DA and forming the corner area 2 together with the one surface 3, the blade piece holding part 30 being fixed to the body part 20; and the blade piece 50 that is held on the blade piece holding part 30 so as to extend at least in the second direction DB. The blade edge 51 of the blade piece 50 is at an angle greater than 0° and smaller than 45° with respect to a plane that is parallel both to the first direction DA and to the second direction DB.

When the blade edge 51 of the blade piece 50 is at an angle greater than 0° with respect to a plane parallel both to the first direction DA and the second direction DB, the blade edge 51 of the blade piece 50 extends in the corner area 2 of the package 1. As a result, it is possible to prevent articles accommodated in the package 1 from being damaged by the blade edge 51 of the blade piece 50. In addition, when the blade edge 51 of the blade piece 50 is at an angle smaller than 45° with respect to the plane parallel both to the first direction DA and to the second direction DB, out of a force received by the blade piece 50 from the package 1 during the cutting of the package 1, a force directed from the package 1 toward the other side in the second direction DB (the side away from the package 1) can be reduced. Thus, during the cutting of the package 1, it is easy to control the cutting cutter 10 so that the cutting cutter 10 is not deviated from the corner area 2 of the package 1. As a result, it is easy to move the cutting cutter 10 along the corner area 2 of the package 1, whereby the operability of the cutting cutter 10 improves.

In addition, in this embodiment, the cutting cutter 10 that cuts the package 1 while moving on the corner area 2 of the package 1 comprises the body part 20 which has: the first contact part 23 that slides on one surface 3 of the package 1 when cutting, the one surface 3 spreading both in the first direction DA that is a moving direction of the cutting cutter 10 when cutting and in the second direction DB orthogonal to the first direction DA and forming the corner area 2; and the grip part 24 gripped by a user when cutting. In addition, the cutting cutter 10 comprises: the blade piece holding part 30 having the second contact part 44 that slides on the other surface 4 of the package 1 when cutting, the other surface 4 spreading both in the third direction DC that is not parallel to the second direction DB and in the first direction DA and forming the corner area 2 together with the one surface 3, the blade piece holding part 30 being fixed to the body part 20; and the blade piece 50 that is held on the blade piece holding part 30 so as to extend at least in the second direction DB. The blade piece holding part 30 holds the blade piece 50 such that the blade piece 50 can be changed in position between the first position in which the blade edge 51 is oriented to the one side in the first direction DA, and the second position in which the blade edge 51 is oriented to the other side in the first direction DA.

According to such a cutting cutter 10, the position of the blade piece 50 with respect to the body part 20 can be suitably changed in accordance with a dominant hand of a user, for example.

In addition, in this embodiment, the cutting cutter 10 that cuts the package 1 while moving on the corner area 2 of the package 1 comprises the body part 20 which has: the first contact part 23 that slides on one surface 3 of the package 1 when cutting, the one surface 3 spreading both in the first direction DA that is a moving direction of the cutting cutter 10 when cutting and in the second direction DB orthogonal to the first direction DA and forming the corner area 2; and the grip part 24 gripped by a user when cutting. In addition, the cutting cutter 10 comprises: the blade piece holding part 30 having the second contact part 44 that slides on the other surface 4 of the package 1 when cutting, the other surface 4 spreading both in the third direction DC that is not parallel to the second direction DB and in the first direction DA and forming the corner area 2 together with the one surface 3, the blade piece holding part 30 being fixed to the body part 20; and the blade piece 50 that is held on the blade piece holding part 30 so as to extend at least in the second direction DB. The second contact part 44 extends linearly along the first direction DA.

According to such a cutting cutter 10, when the cutting cutter 10 is moved in the first direction DA, a frictional force acting between the cutting cutter 10 and the package 1 during cutting can be minimized. Thus, during the cutting of the package 1, the cutting cutter 10 can be restrained from moving in a direction other than the first direction DA. This improves the operability of the cutting cutter 10 when cutting.

Some modification examples of the above-described embodiment are as described above. It goes without saying that the modification examples can be suitably combined and applied.

What is claimed is:

1. A cutting cutter that cuts a package while moving on a corner area of the package, comprising:
a body part having a first contact part that slides on one surface of the package when cutting, the one surface spreading both in a first direction that is a moving direction of the cutting cutter when cutting and in a second direction orthogonal to the first direction and forming the corner area;
a blade piece holding part having a second contact part that slides on the other surface of the package when cutting, the other surface spreading both in a third direction that is not parallel to the second direction and in the first direction and forming the corner area together with the one surface, the blade piece holding part being fixed to the body part;
a blade piece that is held on the blade piece holding part so as to extend at least in the second direction; and
a guard part that is movable, relative to the blade piece holding part, between a guard position in which a distal end of a blade edge of the blade piece is covered from one side in the second direction, the one side being opposite to the blade piece holding part, and an exposure position in which the distal end of the blade piece is exposed to the one side in the second direction;
wherein, when the first contact part of the body part is brought into contact with the one surface of the package, the guard part is pushed by the one surface from the guard position to the exposure position.

2. The cutting cutter according to claim 1, wherein
the guard part is movable along a direction perpendicular both to the first direction and to the second direction.

3. The cutting cutter according to claim 1, wherein
the guard part is positioned inside the body part, when it is located at the exposure position.

4. A cutting cutter that cuts a package while moving on a corner area of the package, comprising:
a body part having: a first contact part that slides on one surface of the package when cutting, the one surface spreading both in a first direction that is a moving direction of the cutting cutter when cutting and in a second direction orthogonal to the first direction and forming the corner area; and a grip part gripped by a user when cutting;
a blade piece holding part having a second contact part that slides on the other surface of the package when cutting, the other surface spreading both in a third direction that is not parallel to the second direction and in the first direction and forming the corner area together with the one surface, the blade piece holding part being fixed to the body part; and
a blade piece that is held on the blade piece holding part so as to extend at least in the second direction;
wherein, in a projection in a direction perpendicular both to the first direction and to the second direction, a distal end of the blade piece is overlapped with the grip part.

5. A cutting cutter that cuts a package while moving on a corner area of the package, comprising:
a body part having: a first contact part that slides on one surface of the package when cutting, the one surface spreading both in a first direction that is a moving direction of the cutting cutter when cutting and in a second direction orthogonal to the first direction and forming the corner area; and a grip part gripped by a user when cutting;
a blade piece holding part having a second contact part that slides on the other surface of the package when cutting, the other surface spreading both in a third direction that is not parallel to the second direction and in the first direction and forming the corner area together with the one surface, the blade piece holding part being fixed to the body part; and
a blade piece that is held on the blade piece holding part so as to extend at least in the second direction;
wherein a blade edge of the blade piece is at an angle greater than 0° and smaller than 45° with respect to a plane that is parallel both to the first direction and to the second direction.

6. A cutting cutter that cuts a package while moving on a corner area of the package, comprising:
a body part having: a first contact part that slides on one surface of the package when cutting, the one surface spreading both in a first direction that is a moving direction of the cutting cutter when cutting and in a second direction orthogonal to the first direction and forming the corner area; and a grip part gripped by a user when cutting;
a blade piece holding part having a second contact part that slides on the other surface of the package when cutting, the other surface spreading both in a third direction that is not parallel to the second direction and in the first direction and forming the corner area together with the one surface, the blade piece holding part being fixed to the body part; and
a blade piece that is held on the blade piece holding part so as to extend at least in the second direction;
wherein the blade piece holding part holds the blade piece such that the blade piece can be changed in position between a first position in which a blade edge of the blade piece is oriented to one side in the first direction, and a second position in which the blade edge is oriented to the other side in the first direction.

7. A cutting cutter that cuts a package while moving on a corner area of the package, comprising:
a body part having: a first contact part that slides on one surface of the package when cutting, the one surface spreading both in a first direction that is a moving direction of the cutting cutter when cutting and in a second direction orthogonal to the first direction and forming the corner area; and a grip part gripped by a user when cutting;
a blade piece holding part having a second contact part that slides on the other surface of the package when cutting, the other surface spreading both in a third direction that is not parallel to the second direction and in the first direction and forming the corner area together with the one surface, the blade piece holding part being fixed to the body part; and
a blade piece that is held on the blade piece holding part so as to extend at least in the second direction;
wherein the second contact part linearly extends along the first direction.
